(19) United States
(12) Patent Application Publication
(10) Pub. No.: US 2010/0201705 A1
(43) Pub. Date: Aug. 12, 2010

(54) IMAGE PROCESSING DEVICE

(76) Inventors: Mariko Takahashi, Tokyo (JP); Narihiro Matoba, Tokyo (JP)

Correspondence Address: BIRCH STEWART KOLASCH & BIRCH, PO BOX 747, FALLS CHURCH, VA, 22040-0747, US

(21) Appl. No.: 12/678,472

(22) PCT Filed: Oct. 17, 2007
(86) PCT No.: PCT/JP2007/070271

§ 371 Date: Mar. 16, 2010

(51) Int. Cl. G09G 5/02

(52) U.S. Cl. 345/600

(57) ABSTRACT

An image processing device includes a specific color specification unit 2 for acquiring RGB color component data about specific colors a and b from a display image 5 by using a mark for specific color specification, a specific color information conversion unit 3 for determining values H respectively corresponding to the hues of the specific colors a and b from an RGB color space by using the RGB color component data about the specific colors a and b, and a color conversion unit 4 for color-converting the specific color a in the display image 5 into the specific color b according to the values respectively corresponding to the hues of the specific colors a and b.

### FIELD OF THE INVENTION

The present invention relates to an image processing device that generates a special image from an inputted image.

### BACKGROUND OF THE INVENTION

For example, patent reference 1 discloses an image processing device that performs a special effect process on an inputted image to generate a special image. The special effect process performed by this image processing device includes a process of specifying a specific color from the inputted image to display an image in which the color of any area other than areas colored in this specific color is black or white, and a process of displaying an image in which a specific color (a color A) is replaced by another specific color (a color B). By using the special effect process of generating an image in which the color of any area other than a partial area colored in a specific color is black or white, e.g. an image of a female's face in which only the color of her lip is maintained and the other colors are replaced by gray so that the partial area is emphasized in the image can be acquired.

[Patent reference 1]

### JP, 2004-7370,A

In conventional image processing devices, an operation regarding special effect processing is complicated, and a GUI (Graphical User Interface) used for carrying out this operation and intended for a computer having a relatively large display screen is disposed. For example, conventional image processing software can carry out various types of special effect processings when it is executed by a computer, though it cannot generate a desired image unless it is handled by a skilled operator because it is relatively difficult to perform an operation of selecting a special effect, setting up the descriptions of the special effect processing, and so on.

Furthermore, in the image processing device disclosed by patent reference 1, on a relatively large display screen on which an inputted image yet to be processed and a special image processed are separately displayed at the same time, and a window showing the descriptions of the user's operation can be displayed, the user is allowed to specify a specific color from the inputted image by using a pointing device such as a mouse.

Thus, conventional image processing devices perform special effect processing and so on via a user interface which adapts to a relatively large display screen. Therefore, a device having a small display screen such as a mobile phone or a digital still camera (referred to as a DSC from here on when required) cannot display a user interface intended for conventional image processing devices on the screen thereof because the user interface is too large.

Furthermore, a mobile phone and a DSC have small input devices, such as key buttons and a jog dial, and both the input devices and the display screen are disposed on the same outer surface of the housing in order to reduce the area occupied by the small input devices. Such an input device is unsuitable for a complicated operation requiring mouse and key operations heavily.

In addition, conventional image processing devices including the image processing device disclosed by patent reference 1 calculate a hue which is a color variable in a special effect processing by using trigonometric functions. For example, after converting R (red), G (green) and B (blue) (described as RGB from here on when required) of the inputted image into an XYZ color space, calculating powers and converting the XYZ color space into a Lab uniform color space, the conventional image processing devices convert the Lab uniform color space into a hue H by performing a complicated arithmetic operation, such as calculations using a trigonometric function (H=atanθ or H=atan (a,b)).

Thus, the conventional image processing devices have a large arithmetic load of the image processing. A problem is therefore that in order to speed up the image processing, a large-scale hardware configuration having a combination of many computing units is required, and it is therefore difficult to implement a small-sized high-speed image processing device.

The present invention is made in order to solve the above-mentioned problems, and it is therefore an object of the present invention to provide an image processing device that can generate a special image at a high speed through a simple input operation.

### DISCLOSURE OF THE INVENTION

In accordance with the present invention, there is provided an image processing device including: a specific color specification unit for acquiring, as color component data about first and second specific colors, color component data of at least one set of image areas which are selected from an image, which is a target for processing, by using a mark for specific color specification which is displayed on a display screen in synchronization with an input operation using an input device and which moves on the image which is the target for processing; a specific color information conversion unit for determining values respectively corresponding to hues of the first and second specific colors from a color space having hue components by using the color component data about the first and second specific colors acquired by the specific color specification unit; and a color conversion unit for color-converting the first specific color in the image which is the target for processing into the second specific color according to the values respectively corresponding to the hues of the first and second specific colors which are determined by the specific color information conversion unit. Because the image processing device is configured in this way, the image processing device provides an advantage of being able to generate a special image which meets a user's needs at a high speed through a simple input operation.

### BRIEF DESCRIPTION OF THE FIGURES

FIG. 1 is a block diagram showing the configuration of an image processing device in accordance with Embodiment 1 of the present invention;

FIG. 2 is a view for explaining an operation of specifying a specific color;

FIG. 3 is a block diagram showing the configuration of an image processing device in accordance with Embodiment 2 of the present invention;

FIG. 4 is a view showing a color bar which an image processing device in accordance with Embodiment 3 of the present invention uses for specification of a specific color;

FIG. 5 is a view showing a gradation color bar which an image processing device in accordance with Embodiment 4 of the present invention uses for specification of a specific color;

FIG. 6 is a view showing another example of the gradation color bar which the image processing device in accordance with Embodiment 4 of the present invention uses for specification of a specific color;

FIG. 7 is a view showing a gradation color circle which the image processing device in accordance with Embodiment 4 of the present invention uses for specification of a specific color;

FIG. 8 is a block diagram showing the configuration of an image processing device in accordance with Embodiment 5 of the present invention;

FIG. 9 is a view for explaining a process of specifying a specific color which is carried out by the image processing device shown in FIG. 8; and

FIG. 10 is a view for explaining another example of the process of specifying a specific color which is carried out by the image processing device shown in FIG. 8.

### PREFERRED EMBODIMENTS OF THE INVENTION

Hereafter, in order to explain this invention in greater detail, the preferred embodiments of the present invention will be described with reference to the accompanying drawings.

### EMBODIMENT 1

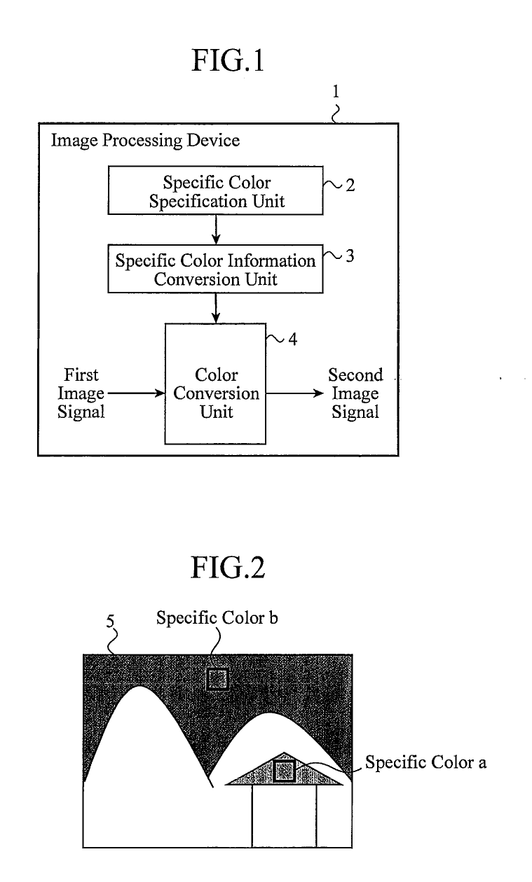

FIG. 1 is a block diagram showing the configuration of an image processing device in accordance with Embodiment 1 of the present invention. In FIG. 1, the image processing device 1 in accordance with Embodiment 1 color-converts a specific color a (a first specific color) into a specific color b (a second specific color) in an image shown by a first image signal inputted thereto. In this case, the first image signal consists of RGB signals, and shows image data about an image which is displayed on the display screen of a display device (not shown) which the image processing device 1 has. A second image signal shows image data about an image in which the specific color a is color-converted into the specific color b in the image shown by the first image signal.

The image processing device 1 in accordance with Embodiment 1 is provided with a specific color specification unit 2, a specific color information conversion unit 3, and a color conversion unit 4. The specific color specification unit 2 is a component for specifying a specific color required for color conversion from the image shown by the first image signal, and provides a GUI for specifying a specific color from the image shown by the first image signal in synchronization with a user's input operation using a not-shown input device.

The specific color information conversion unit 3 converts color component data about each specific color specified by the specific color specification unit 2 into color conversion information applicable to the color conversion process. As this color conversion information, for example, there is a numerical value corresponding to a hue which is calculated from an RGB space by using an RGB ratio corresponding to the RGB data about the specific color. The color conversion information differs dependently upon a color conversion method which is executed by the color conversion unit 4. For example, when the color conversion unit 4 carries out the color conversion in an YCbCr color space or an L*a*b* color space, a numerical value corresponding to a hue defined in the YCbCr color space or the L*a*b* color space is provided as the color conversion information.

The color conversion unit 4 color-converts the image shown by the first image signal by using the color conversion information about each specific color determined by the specific color information conversion unit 3 to output, as the color-converted image, a second image signal. As the color conversion method, for example, a method of simply specifying a hue of a specific color to be color-converted, and color-converting the hue of the specific color to a hue of another specific color to which the specific color is to be color-converted can be used. Furthermore, the color conversion unit can carry out the color conversion in a color space, such as an RGB color space, an YCbCr color space, or an L*a*b* color space.

The above-mentioned specific color specification unit 2, the above-mentioned specific color information conversion unit 3, and the above-mentioned color conversion unit 4 can be implemented as a concrete means in which software and hardware operate in corporation with each other by causing a computer to execute an image processing program according to the scope of the present invention, and then controlling the operation of the computer.

Next, the operation of the image processing device will be explained.

Hereinafter, a case in which the image processing device 1 in accordance with Embodiment 1 is embodied by making a processor of a mobile information terminal having a small display device execute the above-mentioned image processing program will be mentioned as an example. A mobile phone or a DSC can be provided as the above-mentioned mobile information terminal, though the present invention is not limited to this example. For example, the mobile information terminal can be a device which is classified as PDA (Personal Digital Assistants).

First, the specific color specification unit 2 of the image processing device 1 displays the image shown by the first image signal which is the target for image processing on the display screen of the above-mentioned display device. FIG. 2 is a view for explaining an operation of specifying a specific color, and a display image 5 is the image shown by the first image signal displayed on the above-mentioned display screen. In this case, a user specifies a specific color from the display image 5 on the above-mentioned display screen by using a not-shown input device which the above-mentioned mobile information terminal has.

In the example shown in FIG. 2, a case in which by using the not-shown input device, the user marks, as a partial area colored in the specific color a on which the color conversion is to be performed, a part of the roof of the house shown in the display image 5, and also marks, as a partial area colored in the specific color b which is the color into which the specific color a is to be color-converted, a part of the sky shown in the display image 5 is shown. The marking can be displayed in the display image 5 in synchronization with the user's input operation on the above-mentioned input device. In FIG. 2, the partial area colored in each of the specific colors is expressed by a rectangular mark.

When a part of the image is marked, as a partial area colored in each of the specific colors, on the display image 5 by the user in the above-mentioned way, the specific color specification unit 2 acquires RGB data in the above-mentioned partial area as RGB data about each of the specific colors specified by the user. Because each marked part is a minute area consisting of two or more pixels, the specific color specification unit 2 calculates an RGB average value of the pixels in this area to acquire the RGB data about the specific color in each marked part. For example, when one marked part is an area having n pixels in a vertical direction and m pixels in a horizontal direction (n and m are positive integers), the specific color specification unit 2 calculates the RGB average value of the n×m pixels as the RGB value of the specific color in the marked part.

After acquiring the RGB data about the specific colors a and b from the specific color specification unit 2, the specific color information conversion unit 3 calculates both a numerical value corresponding to the hue of the specific color a and a numerical value corresponding to the hue of the specific color b from the RGB data about the specific colors a and b, and outputs these numerical values to the color conversion unit 4 as the color conversion information required for the color conversion by the color conversion unit 4. In this case, the specific color information conversion unit calculates a numerical value H corresponding to each of the hues from the RGB ratio in the RGB color space.

For example, when each RGB data has a value ranging from 0 to 255, the RGB ratio HP of a specific color is shown by the following equation (1). Then, according to the following creation of cases of the RGB ratio HP, a color area in the RGB color space is specified and a numerical value H corresponding to the hue is calculated.

HP=(max(R,G,B)−min(R,G,B))×255/(max(R,G,B)−min(R,G,B)) (1)

At the time of 0<HP≦255 (red to yellow) H=HP

At the time of 255<HP≦255×2 (yellow to green) H=255×2−HP

At the time of 255×2<HP≦255×3 (green to cyan) H=255×2+HP

At the time of 255×3<HP≦255×4 (cyan to blue) H=255×4−HP

At the time of 255×4<HP≦255×5 (blue to magenta) H=255×4+HP

At the time of 255×5<HP≦255×6 (magenta to red) H=255×6−HP

Thus, the image processing device 1 in accordance with Embodiment 1 calculates a numerical value H corresponding to the hue of each specific color according to the RGB ratio of each specific color in the RGB color space. Therefore, the specific color information conversion unit 3 carries out an arithmetic operation excluding multiplications and complicated arithmetic operations using trigonometric functions, unlike conventional image processing devices, but including only the single divider for determining the RGB ratio HP and the conditional branches for the RGB ratio HP. Therefore, the load of the arithmetic operation of calculating a numerical value corresponding to the hue of each specific color can be reduced.

In the above-mentioned explanation, the case in which a numerical value H corresponding to the hue of each specific color is calculated from the RGB ratio of each specific color in the RGB color space is shown. However, the present embodiment is not limited to this example. For example, the specific color information conversion unit 3 can convert the RGB data about the specific colors a and b into YCbCr data as the color conversion information, and calculate a numerical value corresponding to the hue of each of the specific colors from the YCbCr ratio of each of the specific colors in the YCbCr color space. As an alternative, the specific color information conversion unit can convert the RGB data about the specific colors a and b into L*a*b* data as the color conversion information, and calculate a numerical value corresponding to the hue of each of the specific colors in the L*a*b* color space.

The color conversion unit 4 performs color conversion on the image shown by the first image signal according to the color conversion information determined by the specific color information conversion unit 3, and outputs a second image signal as the color-converted image. In the example of FIG. 2, an image in which the specific color a is color-converted into the specific color b in the display image 5 shown by the first image signal is generated, and a second image signal is outputted, as the image, to the display device.

As mentioned above, the image processing device in accordance with this Embodiment 1 includes the specific color specification unit 2 for acquiring, as RGB color component data about specific colors a and b, RGB component data of at least one set of image areas which are selected from a display image 5 by using a mark for specific color specification which can move on the display image 5, the specific color information conversion unit 3 for determining numerical values H respectively corresponding to the hues of the specific colors a and b from an RGB color space having hue components by using the RGB color component data about the specific colors a and b acquired by the specific color specification unit 2, and the color conversion unit 4 for color-converting the specific color a in the display image 5 into the specific color b according to the numerical values respectively corresponding to the hues of the specific colors a and b, which are determined by the specific color information conversion unit 3. Accordingly, since the image processing device in accordance with this Embodiment 1 enables the user to specify the specific colors a and b in the display image 5, the user does not have to perform a complicated operation requiring mouse and key operations heavily, and therefore can specify the specific colors by performing a simple input operation. Furthermore, because the image processing device in accordance with this Embodiment 1 calculates the numerical values H respectively corresponding to the hues of the specific colors a and b from the RGB color space having hue components by using the color component data about the specific colors a and b, the image processing device can calculate, as the color conversion information, the numerical values respectively corresponding to the hues of the specific colors by performing a simple arithmetic operation including a division and conditional branches, the image processing device can remarkably reduce the arithmetic load as compared with conventional image processing devices. Accordingly, the image processing device can generate a special image in which the specific color a is color-converted into the specific color b at a high speed.

In above-mentioned Embodiment 1, the case in which only the set of specific colors a and b are specified and then the specific color a is color-converted into the specific color b is explained, though two or more sets of a specific color to be color-converted and another specific color to which the specific color is to be color-converted can be specified. In this case, the specific color information conversion unit 3 calculates numerical values corresponding to the hues of the specific colors in each set in such a way that a hue area shown by a numerical value corresponding to the hue derived from the data about the specific color to be color-converted in each set does not overlap a hue area shown by a numerical value corresponding to the hue derived from the data about the specific color to be color-converted in any other set, so as to set up a hue area corresponding to the specific color to be color-converted in each set.

### Embodiment 2

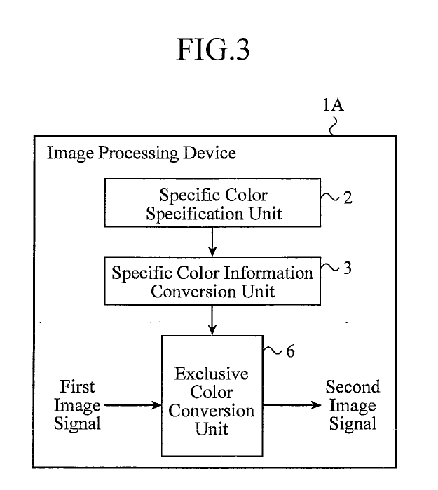

FIG. 3 is a block diagram showing the configuration of an image processing device in accordance with Embodiment 2 of the present invention. In FIG. 3, the image processing device 1A in accordance with Embodiment 2 performs exclusive color conversion on the color of any area other than areas colored in a specific color a which is specified for an image shown by a first image signal inputted thereto to convert the color into black or white. In this case, the first image signal consists of RGB signals, and shows image data about an image which is displayed on the display screen of a display device (not shown) which the image processing device 1 has. A second image signal is image data in which exclusive color conversion is performed on the color of any area other than areas colored in the specific color a which is specified for the image shown by the first image signal to convert the color into black or white.

The image processing device 1A in accordance with Embodiment 2 is provided with a specific color specification unit 2, a specific color information conversion unit 3, and an exclusive color conversion unit 6. The specific color specification unit 2 is a component for specifying a specific color required for the color conversion from the image shown by the first image signal, and provides a GUI for specifying a specific color from the image shown by the first image signal in synchronization with a user's input operation using a not-shown input device.

The specific color information conversion unit 3 converts the data about the specific color specified by the specific color specification unit 2 and preset black and white levels into color conversion information applicable to the exclusive color conversion process. As this color conversion information, for example, there is a numerical value corresponding to a hue which is calculated from an RGB space by using an RGB ratio corresponding to the RGB data about the specific color. The color conversion information differs dependently upon an exclusive color conversion method which is executed by the exclusive color conversion unit 6. For example, when the exclusive color conversion unit 6 carries out the exclusive color conversion in an YCbCr color space or an L*a*b* color space, a numerical value corresponding to a hue defined in the YCbCr color space or the L*a*b* color space is provided as the color conversion information.

The exclusive color conversion unit 6 performs the exclusive color conversion on the image shown by the first image signal by using the color conversion information about the specific color determined by the specific color information conversion unit 3 to output, as the exclusive-color-converted image, a second image signal. Furthermore, the exclusive color conversion unit can carry out the exclusive color conversion in a color space, such as an RGB color space, an YCbCr color space, or an L*a*b* color space.

The above-mentioned specific color specification unit 2, the above-mentioned specific color information conversion unit 3, and the above-mentioned exclusive color conversion unit 6 can be implemented as a concrete means in which software and hardware operate in corporation with each other by causing a computer to execute an image processing program according to the scope of the present invention, and then controlling the operation of the computer.

Next, the operation of the image processing device will be explained.

Hereinafter, a case in which the image processing device 1A in accordance with Embodiment 2 is embodied by making a processor of a mobile information terminal having a small display device execute the above-mentioned image processing program will be mentioned as an example. A mobile phone or a DSC can be provided as the above-mentioned mobile information terminal, though the present invention is not limited to this example. For example, the mobile information terminal can be a device which is classified as PDA (Personal Digital Assistants).

First, the specific color specification unit 2 of the image processing device 1A displays the image shown by the first image signal which is the target for image processing on the display screen of the above-mentioned display device. In this case, a user specifies a specific color from the display image on the above-mentioned display screen by using the not-shown input device which the above-mentioned mobile information terminal has.

An explanation will be made with reference to FIG. 2 shown in above-mentioned Embodiment 1. In the example shown in FIG. 2, by using the not-shown input device, the user marks, as a partial area of a specific color a on which no exclusive color conversion is to be performed (a partial area in which the specific color is not exclusive-color-converted into block or white), for example, a part of the roof of the house shown in the display image 5. The marking can be displayed, as a rectangular mark, in the display image 5 in synchronization with the user's input operation on the above-mentioned input device, like in the case of above-mentioned Embodiment 1.

When a part of the image is marked, as a partial area of the specific color, on the display image 5 by the user in the above-mentioned way, the specific color specification unit 2 acquires RGB data in the above-mentioned partial area as RGB data about the specific color specified by the user. Like in the case of above-mentioned Embodiment 1, because the marked part is a minute area consisting of two or more pixels, the specific color specification unit 2 calculates an RGB average value of the pixels in this area to acquire the RGB data about the specific color in the marked part.

After acquiring the RGB data about the specific color a on which no exclusive color conversion is to be performed from the specific color specification unit 2, the specific color information conversion unit 3 calculates a numerical value corresponding to the hue of the specific color a in the same way as that shown in above-mentioned Embodiment 1. After that, the specific color information conversion unit 3 outputs the numerical value corresponding to the hue of the specific color a on which no exclusive color conversion is to be performed, and preset black and white level data to the exclusive color conversion unit 6 as the color conversion information. In this case, the specific color information conversion unit calculates a numerical value H corresponding to the hue from an RGB ratio in the RGB color space.

The exclusive color conversion unit 6 performs the exclusive color conversion on the image shown by the first image signal according to the color conversion information determined by the specific color information conversion unit 3, and outputs a second image signal as the exclusive-color-converted image. In the example of FIG. 2, an image in which the color of any area other than areas colored in the specific color a is exclusive-color-converted into black or white in the display image 5 shown by the first image signal is generated, and a second image signal is outputted, as the exclusive-color-converted image, to the display device.

As mentioned above, the image processing device in accordance with this Embodiment 2 includes the specific color specification unit 2 for acquiring, as RGB color component data about a specific color a, RGB component data of at least one image area which is selected from a display image 5 by using a mark for specific color specification which can move on the display image 5, the specific color information conversion unit 3 for determining a numerical value H corresponding to the hue of the specific color a from an RGB color space having hue components by using the RGB color component data about the specific color a acquired by the specific color specification unit 2, and the exclusive color conversion unit 6 for color-converting any color other than the specific color a in the display image 5 into black or white according to the numerical value corresponding to the hue of the specific color a, which is determined by the specific color information conversion unit 3. Accordingly, since the image processing device in accordance with this Embodiment 2 enables the user to specify the specific color a in the display image 5, the user does not have to perform a complicated operation requiring mouse and key operations heavily, and therefore can specify the specific color by performing a simple input operation. Furthermore, because the image processing device in accordance with this Embodiment 2 calculates a numerical value H corresponding to the hue of the specific color a from the RGB color space having hue components by using the color component data about the specific color a, the image processing device can calculate, as the color conversion information, the numerical value corresponding to the hue of the specific color by performing a simple arithmetic operation including a division and conditional branches, and remarkably reduce the arithmetic load as compared with conventional image processing devices, like in the case of above-mentioned Embodiment 1. Accordingly, the image processing device can generate a special image in which the image processing device has exclusive-color-converted the color of any area other than areas colored in the specific color a into black or white at a high speed.

In above-mentioned Embodiment 2, the case in which only one specific color is specified and the exclusive color conversion is then performed is explained, though two or more specific colors on which on exclusive color conversion into black or white is to be performed can be specified. In this case, the specific color information conversion unit 3 calculates a numerical value corresponding to the hue of each of the specific colors in such a way that a hue area shown by a numerical value corresponding to the hue derived from the data about each of the specific colors does not overlap a hue area shown by a numerical value corresponding to the hue derived from the data about any other specific color, so as to set up a hue area corresponding to each of the specific colors.

### Embodiment 3

In above-mentioned Embodiments 1 and 2, the configuration for specifying a specific color from an image shown by a first image signal and displayed on a display device is shown. An image processing device in accordance with this Embodiment 3 has the same basic configuration as that in accordance with above-mentioned Embodiment 1 or 2, while the image processing device in accordance with this Embodiment 3 differs from that in accordance with above-mentioned Embodiment 1 or 2 in that it specifies a specific color from a color bar superimposed and displayed on an image shown by a first image signal in a process of specifying a specific color using a specific color specification unit.

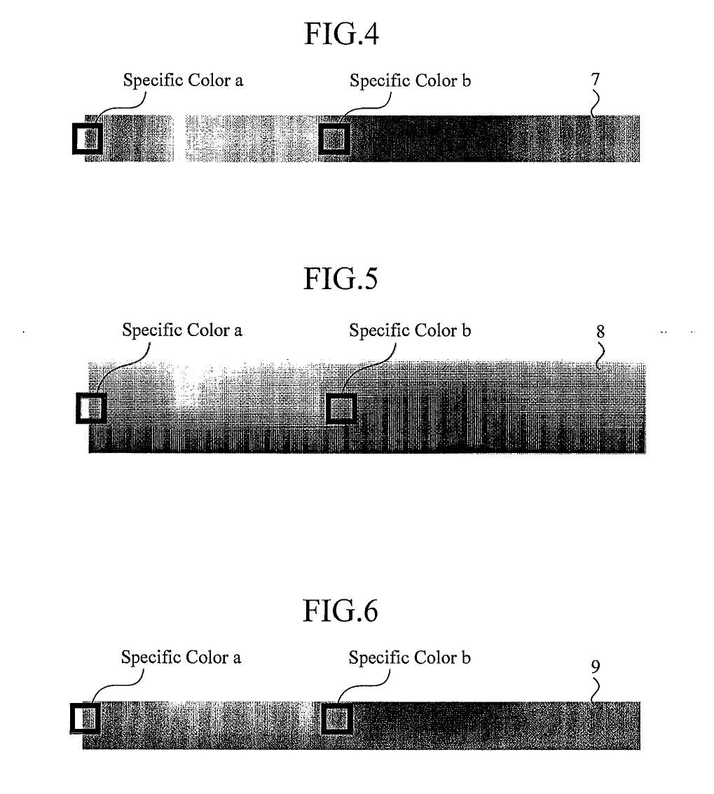

FIG. 4 is a view showing the color bar which the image processing device in accordance with Embodiment 3 of the present invention uses for the specification of a specific color. The color bar 7 includes hues which are arranged in order according to an HSV hue circle in a rectangular frame. Although the color bar 7 is described in black and white in FIG. 4 by the rules for the creation of filing patent application documents, red, apricot, yellow, yellowish green, green, bluish green, blue, bluish purple, purple, and reddish purple are actually arranged in order from a left-hand side to a right-hand side of the color bar 7.

The specific color specification unit 2 in accordance with Embodiment 3 displays an image shown by a first image signal which is the target for image processing on the display screen of a display device while superimposing the color bar 7 on the image. A user specifies a specific color from the above-mentioned color bar 7 on the display screen by using a not-shown input device.

In the example shown in FIG. 4, the user marks, as an area of a specific color a on which color conversion is to be performed, a left end part (a red area) of the color bar 7 by using the not-shown input device, and also marks, as an area of a specific color b to which the specific color a is to be color-converted, a central part (a blue area) of the color bar 7. The marking can be displayed in the color bar 7 in synchronization with the user's input operation on the above-mentioned input device. In FIG. 4, the area of each of the specific colors is expressed by a rectangular mark.

When a partial area of the color bar 7 is marked, as an area of each of the specific colors, by the user in the above-mentioned way, the specific color specification unit 2 acquires RGB data in the above-mentioned partial area as RGB data about each of the specific colors specified by the user. Because each marked part is a minute area consisting of two or more pixels, the specific color specification unit 2 calculates an RGB average value of the pixels in this area to acquire the RGB data about the specific color in each marked part. For example, when one marked part is an area having n pixels in a vertical direction and m pixels in a horizontal direction (n and m are positive integers), the specific color specification unit 2 calculates the RGB average value of the n×m pixels as the RGB value of the specific color in the marked part.

After acquiring the RGB data about the specific colors a and b from the specific color specification unit 2, the specific color information conversion unit 3 calculates both a numerical value corresponding to the hue of the specific color a and a numerical value corresponding to the hue of the specific color b from the RGB data about the specific colors a and b, and outputs these numerical values to the color conversion unit 4 as color conversion information required for the color conversion by the color conversion unit 4. In this case, the specific color information conversion unit calculates a numerical value H corresponding to each of the hues from an RGB ratio in the RGB color space.

The color conversion unit 4 performs the color conversion on the image shown by the first image signal according to the color conversion information determined by the specific color information conversion unit 3, and then outputs a second image signal as the color-converted image. As a result, an image in which the specific color a is color-converted into the specific color b in the image shown by the first image signal is generated, and a second image signal is outputted, as the color-converted image, to the display device.

As mentioned above, because the image processing device in accordance with this Embodiment 3 displays a color bar 7 including hues which are arranged in order according to a hue circle while superimposing the color bar 7 on an image which is the target for processing, and enables the user to select specific colors from this color bar 7, the user can easily recognize the hue of each of the specific colors visually, and can also select each of the specific colors by simply marking a corresponding area.

In above-mentioned Embodiment 3, the case in which the image processing device color-converts a specific color a to a specific color b as in the case of above-mentioned Embodiment 1 is shown. As an alternative, the color bar 7 in accordance with above-mentioned Embodiment 3 can be applied to the configuration in accordance with above-mentioned Embodiment 2, and the image processing device can exclusive-color-convert the color of any area other than areas colored in a specific color a specified from the color bar 7 into black or white.

### Embodiment 4

In above-mentioned Embodiment 3, the configuration of specifying a specific color from a color bar in which hues are arranged in order according to a hue circle is shown. An image processing device in accordance with this Embodiment 4 has the same basic configuration as that in accordance with above-mentioned Embodiment 1, 2 or 3, while the image processing device in accordance with this Embodiment 4 differs from that in accordance with above-mentioned Embodiment 1, 2 or 3 in that it specifies a specific color from a gradation color bar or a gradation color circle superimposed and displayed on an image shown by a first image signal in a process of specifying a specific color using a specific color specification unit.

FIG. 5 is a view showing the gradation color bar which the image processing device in accordance with Embodiment 4 of the present invention uses for the specification of a specific color. The gradation color bar 8 includes hues which are arranged in a horizontal direction in a rectangular frame and in order according to an HSV hue circle with their brightnesses being varied gradually along a vertical direction in the above-mentioned rectangular frame. Although the gradation color bar 8 is described in black and white in FIG. 5 by the rules for the creation of filing patent application documents, red, apricot, yellow, yellowish green, green, bluish green, blue, bluish purple, purple, and reddish purple are actually arranged in order from a left-hand side to a right-hand side of the gradation color bar 8, and their brightnesses are increased gradually along a vertical direction from a lower side to an upper side.

FIG. 6 is a view showing another example of the gradation color bar which the image processing device in accordance with Embodiment 4 uses for the specification of a specific color. The gradation color bar 9 includes hues which are arranged in a horizontal direction in a rectangular frame and in order according to an HSV hue circle with their color saturations being varied gradually along a vertical direction in the above-mentioned rectangular frame. Although the gradation color bar 9 is described in black and white in FIG. 6 by the rules for the creation of filing patent application documents, red, apricot, yellow, yellowish green, green, bluish green, blue, bluish purple, purple, and reddish purple are actually arranged in order from a left-hand side to a right-hand side of the gradation color bar 9, and their color saturations are increased gradually along a vertical direction from a lower side to an upper side.

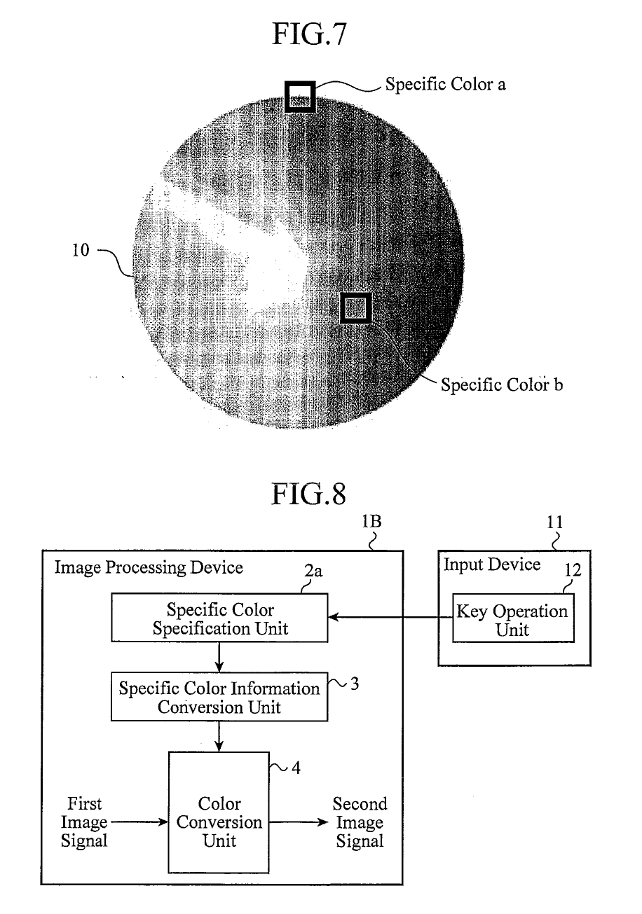

FIG. 7 is a view showing the gradation color circle which the image processing device in accordance with Embodiment 4 uses for the specification of a specific color. The gradation color circle 10 includes hues which are arranged in the form of a circle and in order according to an HSV hue circle in a circular frame with their color saturations being varied gradually along a direction from the center of the above-mentioned circular frame toward the outer edge of the circular frame. Although the gradation color circle 10 is described in black and white in FIG. 7 by the rules for the creation of filing patent application documents, red, apricot, yellow, yellowish green, green, bluish green, blue, bluish purple, purple, and reddish purple are actually arranged in the form of a circle and in order, and their color saturations are increased gradually along the direction from the center of the circular frame toward the outer edge of the circular frame.

The specific color specification unit 2 in accordance with Embodiment 4 displays an image shown by a first image signal which is the target for image processing on the display screen of a display device while superimposing the gradation color bar 8 (the gradation color bar 9 or the gradation color circle 10) on the image. A user specifies a specific color from the above-mentioned gradation color bar 8 (the gradation color bar 9 or the gradation color circle 10) on the display screen by using a not-shown input device.

In the example shown in FIG. 5, a case in which the user marks, as an area of a specific color a on which the color conversion is to be performed, an area (a red area with an intermediate brightness) at a left end and at a middle vertical position of the gradation color bar 8 by using the not-shown input device, and also marks, as an area of a specific color b to which the specific color a is to be color-converted, a central area (a blue area) at a middle vertical position of the gradation color bar 8 is shown. The marking can be displayed in the gradation color bar 8 in synchronization with the user's input operation on the above-mentioned input device. In FIG. 5, the area of each of the specific colors is expressed by a rectangular mark.

In the example shown in FIG. 6, a case in which the user marks, as an area of a specific color a on which the color conversion is to be performed, an area (a red area with a color saturation higher than an intermediate one) at a left end and at an upper vertical position of the gradation color bar 9 by using the not-shown input device, and also marks, as an area of a specific color b to which the specific color a is to be color-converted, a central area (a blue area with a color saturation higher than an intermediate one) at an upper vertical position of the gradation color bar 8 is shown. The marking can be displayed in the gradation color bar 8 in synchronization with the user's input operation on the above-mentioned input device. In FIG. 6, the area of each of the specific colors is expressed by a rectangular mark.

In the example shown in FIG. 7, a case in which the user marks, as an area of a specific color a on which the color conversion is to be performed, an outer edge area (an area with a maximum color saturation) in which a red color is placed in the gradation color circle 10 by using the not-shown input device, and also marks, as an area of a specific color b to which the specific color a is to be color-converted, a middle area (an area with an intermediate color saturation) in which a blue color is placed between the center and the outer edge of the gradation color circle 10 is shown. The marking can be displayed in the gradation color circle 10 in synchronization with the user's input operation on the above-mentioned input device. In FIG. 7, the area of each of the specific colors is expressed by a rectangular mark.

When a partial area of the gradation color bar 8 (the gradation color bar 9 or the gradation color circle 10) is marked, as an area of each of the specific colors, by the user in the above-mentioned way, the specific color specification unit 2 acquires RGB data in the above-mentioned partial area as RGB data about each of the specific colors specified by the user. Because each marked part is a minute area consisting of two or more pixels, the specific color specification unit 2 calculates an RGB average value of the pixels in this area to acquire the RGB data about the specific color in each marked part. For example, when one marked part is an area having n pixels in a vertical direction and m pixels in a horizontal direction (n and m are positive integers), the specific color specification unit 2 calculates the RGB average value of the n×m pixels as the RGB value of the specific color in the marked part.

After acquiring the RGB data about the specific colors a and b from the specific color specification unit 2, the specific color information conversion unit 3 calculates both a numerical value corresponding to the hue of the specific color a and a numerical value corresponding to the hue of the specific color b from the RGB data about the specific colors a and b, and outputs these numerical values to the color conversion unit 4 as the color conversion information required for the color conversion by the color conversion unit 4. In this case, the specific color information conversion unit calculates a numerical value H corresponding to each of the hues from an RGB ratio in the RGB color space.

The color conversion unit 4 performs the color conversion on the image shown by the first image signal according to the color conversion information determined by the specific color information conversion unit 3, and then outputs a second image signal as the color-converted image. As a result, an image in which the specific color a is color-converted into the specific color b in the image shown by the first image signal is generated, and a second image signal is outputted, as the color-converted image, to the display device.

As mentioned above, because the image processing device in accordance with this Embodiment 4 displays at least one of a gradation color bar 8 including hues which are arranged in a horizontal direction in a rectangular frame and in order according to a hue circle with their brightnesses being varied gradually along a vertical direction in the rectangular frame, a gradation color bar 9 including hues which are arranged in a horizontal direction in a rectangular frame and in order according to a hue circle with their color saturations being varied gradually along a vertical direction in the rectangular frame, and a gradation color circle 10 including hues which are arranged in the form of a circle in a circular frame and in order according to a hue circle with their color saturations being varied gradually along a direction from the center of the circular frame toward the outer edge of the circular frame, while superimposing the gradation color bar 8, the gradation color bar 9 or the gradation color circle 10 on an image which is the target for processing, and enables the user to select a specific color from the gradation color bar 8 (the gradation color bar 9 or the gradation color circle 10), the user can easily recognize the hue and brightness or color saturation of a specific color visually, and can also select a specific color by simply marking a corresponding area.

In above-mentioned Embodiment 4, the case in which the image processing device color-converts a specific color a to a specific color b as in the case of above-mentioned Embodiment 1 is shown. As an alternative, the gradation color bar 8 (the gradation color bar 9 or the gradation color circle 10) in accordance with above-mentioned Embodiment 4 can be applied to the configuration in accordance with above-mentioned Embodiment 2, and the image processing device can exclusive-color-convert the color of any area other than areas colored in a specific color a specified from the gradation color bar 8 (the gradation color bar 9 or the gradation color circle 10) into black or white.

### Embodiment 5

FIG. 8 is a block diagram showing the configuration of an image processing device in accordance with Embodiment 5 of the present invention. In FIG. 8, the image processing device 1B in accordance with Embodiment 5 color-converts a specific color a into a specific color b in an image shown by a first image signal inputted thereto. In this case, the first image signal consists of RGB signals, and shows image data about an image which is displayed on the display screen of a display device (not shown) which the image processing device 1B has, as in the case of above-mentioned Embodiment 1. A second image signal shows image data about an image in which the specific color a has been color-converted into the specific color b in the image shown by the first image signal.

The image processing device 1B in accordance with Embodiment 5 is provided with a specific color specification unit 2a, a specific color information conversion unit 3, and a color conversion unit 4. The specific color specification unit 2a is a component for specifying a specific color required for color conversion, and provides a GUI for specifying a specific color in synchronization with a user's input operation using a key operation unit 12 of an input device 11.

The specific color information conversion unit 3 converts data about each specific color specified by the specific color specification unit 2a into color conversion information applicable to the color conversion process. A method of determining this color conversion information is the same as that shown in above-mentioned Embodiment 1. The color conversion unit 4 color-converts the image shown by the first image signal by using the color conversion information about the specific colors determined by the specific color information conversion unit 3 to output a second image signal as the color-converted image. A method of color-converting the image is the same as that shown in above-mentioned Embodiment 1. The input device 11 enables a user to perform an input operation on the image processing device 1B, and has the key operation unit 12. For example, a jog dial is disposed in the key operation unit 12.

The above-mentioned specific color specification unit 2a, the above-mentioned specific color information conversion unit 3, and the above-mentioned color conversion unit 4 can be implemented as a concrete means in which software and hardware operate in corporation with each other by causing a computer to execute an image processing program according to the scope of the present invention, and then controlling the operation of the computer.

Next, the operation of the image processing device will be explained.

### (1) In a Case of Using a Color Bar or a Gradation Color Bar

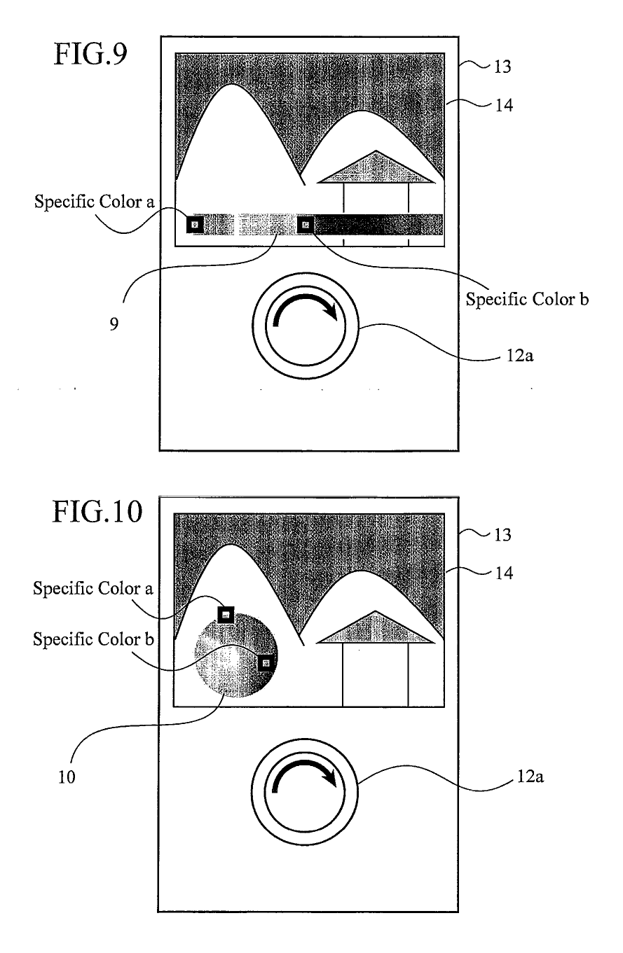

FIG. 9 is a view for explaining a process of specifying a specific color which is carried out by the image processing device shown in FIG. 8. In FIG. 9, the image processing device 1B in accordance with Embodiment 5 is embodied by making a processor of a mobile information terminal 13 execute the above-mentioned image processing program. This mobile information terminal 13 has a display device 14, and a jog dial 12a as the key operation unit 12. A mobile phone or a DSC can be provided as the mobile information terminal 13, though the present invention is not limited to this example. For example, the mobile information terminal can be a PDA.

The specific color specification unit 2a displays an image shown by a first image signal which is the target for image processing on the display screen of the display device 14 while superimposing a gradation color bar 9 shown in FIG. 6 on the image. A user specifies a specific color from the gradation color bar 9 on the above-mentioned display screen by using the jog dial 12a.

A mark for specific color specification expressed by a rectangle in FIG. 9 is one element of a GUI which is provided for the specification of a specific color by the specific color specification unit 2a via the display device 14, and moves on the gradation color bar 9 in synchronization with a movement of the jog dial 12a. For example, the image processing device enables the user to move the mark for specific color specification in a direction from a left side to a right side on the gradation color bar 9 by turning the jog dial 12a clockwise as shown by an arrow in FIG. 9.

The image processing device also enables the user to push down a circular plate portion of the jog dial 12a in a vertical direction or in a horizontal direction by using the circular plate as a cross key to move the mark for specific color specification in that direction on the gradation color bar 9. The image processing device further enables the user to push down the circular plate portion of the jog dial 12a in a diagonal direction to move the mark for specific color specification in a diagonal direction on the gradation color bar 9.

When a partial area of the gradation color bar 9 is marked, as an area of each specific color, by the user by using the mark for specific color specification in the above-mentioned way, the specific color specification unit 2a acquires RGB data in the above-mentioned partial area as RGB data about each specific color specified by the user. In the example shown in FIG. 9, a case in which the user marks, as an area of a specific color a on which the color conversion is to be performed, an area (a red area with a color saturation higher than an intermediate one) at a left end and at an upper vertical position of the gradation color bar 9 by using the jog dial 12a, and also marks, as an area of a specific color b to which the specific color a is to be color-converted, a central area (a blue area with a color saturation higher than an intermediate one) at an upper vertical position of the gradation color bar 8 is shown.

After acquiring the RGB data about the specific colors a and b from the specific color specification unit 2a, the specific color information conversion unit 3 calculates both a numerical value corresponding to the hue of the specific color a and a numerical value corresponding to the hue of the specific color b from the RGB data about the specific colors a and b, and outputs these numerical values to the color conversion unit 4 as the color conversion information required for the color conversion by the color conversion unit 4. In this case, the specific color information conversion unit calculates a numerical value H corresponding to each of the hues from the RGB ratio of each specific color in the RGB color space.

The color conversion unit 4 performs the color conversion on the image shown by the first image signal according to the color conversion information determined by the specific color information conversion unit 3, and then outputs a second image signal as the color-converted image. As a result, an image in which the specific color a is color-converted into the specific color b in the image shown by the first image signal is generated, and a second image signal is outputted, as the color-converted image, to the display device 14.

In the above-mentioned explanation, the case in which the image processing device uses the gradation color bar 9 as a tool used for specifying a specific color is shown. The image processing device can alternatively use either a color bar 7 as shown in FIG. 4 or a gradation color bar 8 as shown in FIG. 5.

### (2) In a Case of Using a Gradation Color Circle

FIG. 10 is a view for explaining another example of the process of specifying a specific color which is carried out by the image processing device shown in FIG. 8. Also in FIG. 10, the image processing device 1B in accordance with Embodiment 5 is embodied by making a processor of a mobile information terminal 13 execute the above-mentioned image processing program, like in the case of FIG. 9. This mobile information terminal 13 has a display device 14, and a jog dial 12a as the key operation unit 12.

The specific color specification unit 2a displays an image shown by a first image signal which is the target for image processing on the display screen of the display device 14 while superimposing the gradation color circle 10 shown in FIG. 7 on the image. A user specifies a specific color from the gradation color circle 10 on the above-mentioned display screen by using the jog dial 12a.

A mark for specific color specification expressed by a rectangle in FIG. 10 is one element of a GUI which is provided for the specification of a specific color by the specific color specification unit 2a via the display device 14, and moves on the gradation color circle 10 in synchronization with a movement of the jog dial 12a. For example, the image processing device enables the user to move the mark for specific color specification clockwise on the gradation color circle 10 by turning the jog dial 12a clockwise as shown by an arrow in FIG. 10.

The image processing device also enables the user to push down a circular plate portion of the jog dial 12a in a vertical direction or in a horizontal direction by using the circular plate as a cross key to move the mark for specific color specification in that direction on the gradation color circle 10. The image processing device further enables the user to push down the circular plate portion of the jog dial 12a in a diagonal direction to move the mark for specific color specification in a diagonal direction on the gradation color circle 10.

In the example shown in FIG. 10, a case in which the user marks, as an area of a specific color a on which the color conversion is to be performed, an outer edge area (an area with a maximum color saturation) in which a red color is placed in the gradation color circle 10 by using the jog dial 12a, and also marks, as an area of a specific color b to which the specific color a is to be color-converted, a middle area (an area with an intermediate color saturation) in which a blue color is placed between the center and the outer edge of the gradation color circle 10 is shown.

When a partial area of the gradation color circle 10 is marked, as an area of each specific color, by the user by using the mark for specific color specification in the above-mentioned way, the specific color specification unit 2a acquires RGB data in the above-mentioned partial area as RGB data about each specific color specified by the user. The subsequent processes carried out by the specific color information conversion units 3 and the color conversion unit 4 are the same as those as shown in above-mentioned (1).

As mentioned above, the image processing device in accordance with this Embodiment 5 includes the key operation units 12, such as the jog dial 12a, which enables the mark for specific color specification to move on the gradation color bar 9 (the color bar 7, the gradation color bar 8, or the gradation color circle 10) in synchronization with an operation (an input operation). Therefore, the user can easily and visually recognize the hue, brightness, or color saturation of a specific color, and can also select a specific color by performing marking with a simple input operation.

In above-mentioned Embodiment 5, the case where the image processing device color-converts a specific color a into a specific color b, like in the case of above-mentioned Embodiment 1 is shown. As an alternative, the image processing device in accordance with this Embodiment 5 can be configured in such a way as to exclusive-color-convert the color of any area other than areas colored in a specific color a specified from the gradation color bar 8 (the color bar 7, the gradation color bar 9, or the gradation color circle 10) into black or white.

### INDUSTRIAL APPLICABILITY

As mentioned above, because the image processing device in accordance with the present invention can generate a special image at a high speed through a simple input operation, the image processing device in accordance with the present invention is suitable for mobile equipment having a display device, such as a mobile phone or a DSC.

1-12. (canceled)

13. An image processing device comprising:
a specific color specification unit for acquiring, as color component data about first and second specific colors, color component data of at least one set of image areas which are selected from an image, which is a target for processing, by using a mark for specific color specification which is displayed on a display screen in synchronization with an input operation using an input device and which moves on said image which is the target for processing;
a specific color information conversion unit for determining values respectively corresponding to hues of said first and second specific colors by respectively specifying color areas in a color space having hue components with ratios of the color component data about said first and second specific colors acquired by said specific color specification unit by using said color component data; and
a color conversion unit for color-converting said first specific color in the image which is said target for processing into said second specific color according to the values respectively corresponding to the hues of said first and second specific colors which are determined by said specific color information conversion unit.

14. The image processing device according to claim 13, characterized in that the specific color specification unit acquires, as each of the color component data about the first and second specific colors, color component data of an image area which is selected from a color bar, which is displayed on the display screen while being superimposed on the image which is the target for processing, by using the mark for specific color specification, the color bar including hues which are arranged in a horizontal direction in a rectangular frame and in order according to a hue circle.

15. The image processing device according to claim 13, characterized in that the specific color specification unit acquires, as each of the color component data about the first and second specific colors, color component data of an image area which is selected from a gradation color bar, which is displayed on the display screen while being superimposed on the image which is the target for processing, by using the mark for specific color specification, the gradation color bar including hues which are arranged in a horizontal direction in a rectangular frame and in order according to a hue circle with their brightnesses being gradually varied along a vertical direction in said rectangular frame.

16. The image processing device according to claim 13, characterized in that the specific color specification unit acquires, as each of the color component data about the first and second specific colors, color component data of an image area which is selected from a gradation color bar, which is displayed on the display screen while being superimposed on the image which is the target for processing, by using the mark for specific color specification, the gradation color bar including hues which are arranged in a horizontal direction in a rectangular frame and in order according to a hue circle with their color saturations being gradually varied along a vertical direction in said rectangular frame.

17. The image processing device according to claim 13, characterized in that the specific color specification unit acquires, as each of the color component data about the first and second specific colors, color component data of an image area which is selected from a gradation color circle, which is displayed on the display screen in synchronization with an input operation using the input device while being superimposed on the image which is the target for processing, by using the mark for specific color specification, the gradation color circle including hues which are arranged in a form of a circle in a circular frame and in order according to a hue circle with their color saturations being gradually varied along a direction from a center of said circular frame toward an outer edge of said circular frame.

18. The image processing device according to claim 13, characterized in that the image processing device includes the input device for enabling the mark for specific color specification to move according to an input operation on the input device.

19. An image processing device comprising:
a specific color specification unit for acquiring, as color component data about a specific color, color component data of at least one image area which is selected from an image, which is a target for processing, by using a mark for specific color specification which is displayed on a display screen in synchronization with an input operation using an input device and which moves on said image which is the target for processing;
a specific color information conversion unit for determining a value corresponding to a hue of said specific color by specifying a color area in a color space having hue components with a ratio of the color component data about said specific color acquired by said specific color specification unit by using said color component data; and
a color conversion unit for color-converting any color other than said specific color in the image which is said target for processing to black or while according to the value corresponding to the hue of said specific color which is determined by said specific color information conversion unit.

20. The image processing device according to claim 19, characterized in that the specific color specification unit acquires, as the color component data about the specific color, color component data of an image area which is selected from a color bar, which is displayed on the display screen while being superimposed on the image which is the target for processing, by using the mark for specific color specification, the color bar including hues which are arranged in a horizontal direction in a rectangular frame and in order according to a hue circle.

21. The image processing device according to claim 19, characterized in that the specific color specification unit acquires, as the color component data about the specific color, color component data of an image area which is selected from a gradation color bar, which is displayed on the display screen while being superimposed on the image which is the target for processing, by using the mark for specific color specification, the gradation color bar including hues which are arranged in a horizontal direction in a rectangular frame and in order according to a hue circle with their brightnesses being gradually varied along a vertical direction in said rectangular frame.

22. The image processing device according to claim 19, characterized in that the specific color specification unit acquires, as the color component data about the specific color, color component data of an image area which is selected from a gradation color bar, which is displayed on the display screen while being superimposed on the image which is the target for processing, by using the mark for specific color specification, the gradation color bar including hues which are arranged in a horizontal direction in a rectangular frame and in order according to a hue circle with their color saturations being gradually varied along a vertical direction in said rectangular frame.

23. The image processing device according to claim 19, characterized in that the specific color specification unit acquires, as the color component data about the specific color, color component data of an image area which is selected from a gradation color circle, which is displayed on the display screen in synchronization with an input operation using the input device while being superimposed on the image which is the target for processing, by using the mark for specific color specification, the gradation color circle including hues which are arranged in a form of a circle in a circular frame and in order according to a hue circle with their color saturations being gradually varied along a direction from a center of said circular frame toward an outer edge of said circular frame.

24. The image processing device according to claim 19, characterized in that the image processing device includes the input device for enabling the mark for specific color specification to move according to an input operation on the input device.
